(19) United States
(12) Patent Application Publication
(10) Pub. No.: US 2009/0042500 A1
(43) Pub. Date: Feb. 12, 2009

(54) Hood and pollution control unit with ultra violet light and electro-static precipitator

(76) Inventors: Russell Robison, Yamhill, OR (US); Keven Hass, Tigard, OR (US); Bruce Lukens, Newberg, OR (US)

Correspondence Address: GREER, BURNS & CRAIN, LTD., 300 S. WACKER DRIVE, SUITE 2500, CHICAGO, IL, 60606, US

(21) Appl. No.: 11/890,560

(22) Filed: Aug. 7, 2007

(51) Int. Cl. B08B 15/02

(52) U.S. Cl. 454/67

(57) ABSTRACT

A ventilator assembly for removing contaminants in cooking exhaust includes a hood portion having a hood plenum and an exhaust portion downstream of and in fluid communication with the hood plenum. An electro-static precipitator is disposed in the hood plenum or the exhaust portion, and at least one ultra-violet lamp is disposed upstream of the electro-static precipitator for cleaning the electro-static precipitator. The ultra-violet radiation reacts with the cooking exhaust and removes collected contaminants from an electro-static cell of the electro-static precipitator.

### BACKGROUND OF THE INVENTION

The present invention relates generally to exhaust systems used in commercial kitchens, and more particularly, to kitchen ventilator systems that use ultra-violet light for reacting with air laden with grease, smoke, fumes and moisture rising from various types of cooking units.

Kitchen ventilator systems typically include a hood mounted above the cooking appliances and connected to a remote source of vacuum or suction for capturing cooking exhaust. In a commercial kitchen, for example, there are usually a number of cooking units lined up side-by-side in a row. Some of these cooking units, such as broilers and fryers, produce considerable quantities of cooking exhaust. The ventilator hood typically includes an inlet opening above the cooking units for capturing the cooking exhaust.

Conventionally, kitchen ventilator systems incorporate mechanical removal devices, such as extraction baffles, filters and particulate separators disposed in the vacuum-enhanced flow path of the cooking exhaust. The filters and particulate separators remove grease particulate from the cooking exhaust, and the baffles create a winding flow path, which causes a mechanical, centrifugal grease extraction from the cooking exhaust. Conventional kitchen ventilator systems often include water wash systems to wash down internal hood surfaces and or components.

Ultra-violet (UV) lamps are conventionally located in the hood plenum downstream of the extraction baffles and the particulate separator, typically in one or more UV light frames, depending on the ventilator length. Radiation from the UV lamps causes ozone to be generated from oxygen that is present in the exhaust air. The ozone, in turn, oxidizes the organic contaminants, such as the grease particulate.

It is known to use electro-static precipitators to clean exhaust air of grease and other cooking contaminants before the air is discharged into the atmosphere. Since an electro-static precipitator can remove small particles not efficiently captured by other filtration devices, the electro-static precipitator is typically the terminal cleaning device before the air is discharged. Conventionally, the electro-static precipitators are located in a pollution control unit that is usually mounted on the roof of the restaurant or other facility, or in a mechanical room above the hood. In addition to the pollution control units being large, the units also require wiring and plumbing, which take up additional overhead space.

Since the contaminant particles are attracted to the charged plates of the electro-static precipitator, the plates become covered with a coating of the contaminant particles. For continued efficient operation, it is necessary that the plates be cleaned periodically. In some installations, the plates are removed for cleaning. It is also known to position spray nozzles on opposite sides of the electro-static precipitator cell to clean the plates while in place. If the plates are not sufficiently maintained, and contaminants are permitted to build on the plates, arcing between the plates can occur, which can cause the electro-static precipitator to short out and fail.

Thus, there is a need for an improved kitchen ventilator system having an electro-static precipitator that requires less maintenance.

There is a further need for an improved kitchen ventilation system in which less overhead space is required for the exhaust portion.

### BRIEF SUMMARY OF THE INVENTION

The above-listed needs are met or exceeded by the present ventilator assembly having an electro-static precipitator that requires less maintenance. The ventilator assembly includes a hood portion having a hood plenum, and an exhaust portion downstream of and in fluid communication with the hood plenum. The electro-static precipitator is disposed in either the hood plenum or the exhaust portion, and at least one ultra-violet lamp is disposed upstream of the electro-static precipitator for cleaning the electro-static precipitator. The ultra-violet radiation reacts with the cooking exhaust and removes collected contaminants from an electro-static cell of the electro-static precipitator.

More specifically, a ventilator assembly for removing contaminants in cooking exhaust includes a hood portion having a hood plenum, and an electro-static precipitator disposed in the hood plenum. At least one ultra-violet lamp for generating ultra-violet radiation is disposed in the hood plenum upstream of the electro-static precipitator. The ultra-violet radiation reacts with the cooking exhaust and removes collected contaminants from an electro-static cell of the electro-static precipitator.

In an alternate ventilator assembly, the assembly includes a hood portion having a hood plenum, and an exhaust portion downstream of and in fluid communication with the hood plenum. An electro-static precipitator is disposed in the exhaust portion. At least one ultra-violet lamp for generating ultra-violet radiation is also disposed in the exhaust portion upstream of the electro-static precipitator. The ultra-violet radiation reacts with the cooking exhaust and removes collected contaminants from an electro-static cell of the electro-static precipitator.

### BRIEF DESCRIPTION OF THE DRAWINGS

FIG. 1 is a schematic section view of the present ventilation system;

FIG. 2 is an enlarged fragmentary view of the system of FIG. 1; and

FIG. 3 is a schematic section view of an alternate ventilation system.

### DETAILED DESCRIPTION OF THE INVENTION

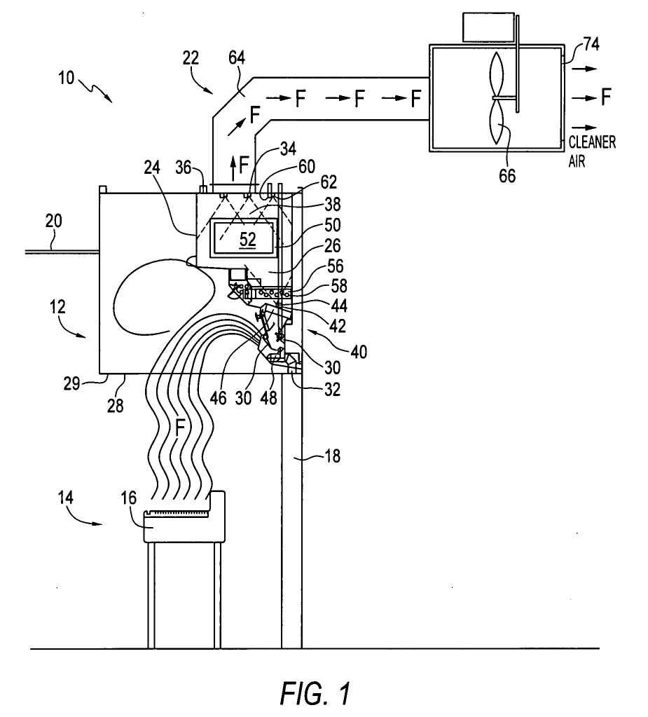

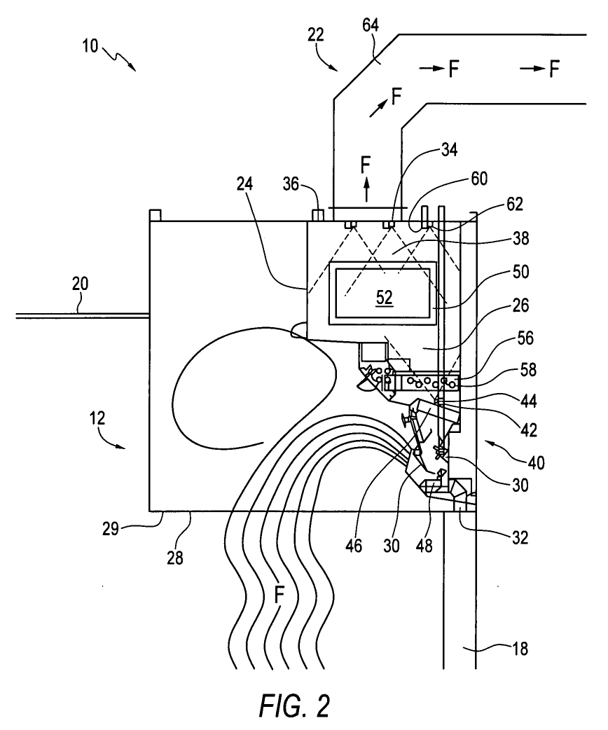

Referring to FIGS. 1 and 2, a ventilator assembly 10 has a hood portion, indicated generally at 12, which is typically positioned above a large commercial cooking area, indicated generally at 14, that may include one or more cooking stations 16 such as a griddle, range, fryer, and/or broiler, and is typically mounted to a wall 18 or hung from a ceiling 20 over the cooking area. The terms “upstream” and “downstream” refer to the direction of flow of the cooking exhaust. For example, the cooking station 16 is the upstream source of the cooking exhaust.

An exhaust portion of the ventilator assembly 10, indicated generally at 22, is located on the downstream side and is in fluid communication with the hood portion 12. At least a portion of the exhaust portion 22 is preferably located above the ceiling 20 of a facility, such as a commercial kitchen or restaurant, and in the preferred embodiment of FIG. 1, the entire exhaust portion is located above the ceiling.

The ventilator assembly 10 includes an outer housing 24 encompassing and defining an interior hood plenum 26. The ventilator assembly 10 is preferably constructed of stainless steel, and more preferably constructed of a stainless steel, preferably of not less than 18 gauge, series 300.

An air inlet aperture 28 is provided at a lower surface 29 of the hood portion 12. The air inlet aperture 28 and is typically positioned over the top of the cooking stations 16 to capture the cooking exhaust.

In the hood plenum 26, there is at least one grease extraction baffle 30 to define a flowpath “F” of the cooking exhaust through the hood portion 12. In the preferred embodiment of FIG. 1, multiple grease extraction baffles 30 are positioned in the plenum 26 to cause the flow path “F” to wind or have a convoluted shape, which causes a mechanical, centrifugal grease extraction from the cooking exhaust. The grease extraction baffles 30 remove particulate that is about 10 microns and larger. Additionally, the grease extraction baffles 30 are sloped to collect and drain the extracted grease particulate out of the hood plenum 26 at a drainpipe 32.

An exhaust outlet 34 of the hood plenum 26 is located along a top surface 36 of the hood portion 12. The exhaust outlet 34 is in fluid communication with the exhaust portion 22. In this configuration, the flow path “F” through the ventilator assembly 10 extends from the air inlet aperture 28, up through the interior of the hood plenum 26, past the grease extraction baffles 30, to an upper portion 38 of the hood plenum and to the exhaust outlet 34, which leads to the exhaust portion 22.

The ventilator assembly 10 is optionally equipped with a water wash system, indicated generally at 40 to periodically clean the ventilator assembly feeding a combination of hot water and a cleaning agent internally to the hood portion 12. Inside the hood plenum 26, an optional wash manifold 42 including at least one spray nozzle 44 provides water (shown schematically as broken lines), to remove the accumulation of extracted grease from the extraction baffles 30, as well as other portions of the hood 12.

A secondary grease removal filter 46 is preferably located downstream of the baffles 30, and is also cleaned by the water emitted from the spray nozzle 44. The secondary grease removal filter 46 removes contaminant particles of about 2 microns or larger.

A gutter 48 is preferably located near the lower surface 29 of the hood portion 12, and preferably has a slight incline to collect and drain the water and grease into the drainpipe 32 from the optional water wash system 40. The water wash system 40 may be implemented automatically on a timed basis or manually at the direction of the user.

Downstream of the secondary filter 46 is an electro-static precipitator 50 for the removal of particulate that is about 0.3 microns or larger, which includes smoke, grease and other contaminants. Conventionally, electro-static precipitators are located in a pollution control unit that is usually mounted in the exhaust portion 22, such as on the roof of the restaurant or other facility, or in a mechanical room above the hood. However, in the ventilator assembly 10, the electro-static precipitator 50 is disposed in the hood portion 12.

The basic operation of an electro-static precipitator 50 is known and includes a cell 52 having conductive plates (not shown), often made of aluminum, that are closely spaced, such as about one-quarter inch apart. In the electro-static cell 52, alternate plates are energized, for example with 5,000 volts of DC power. The plates located between the energized plates are grounded. A series of ionizing wires (not shown) are energized with 10,000 volts DC. As the particles of the flowpath F enter the electro-static precipitator 50, the contaminant particles pass over the ionizing wires and receive a positive charge. The positive plates repel the particles, and the negative or grounded plates attract the particles.

Since the contaminant particles are attracted to the charged plates of the electro-static precipitator 50 in use, the plates eventually become covered with a coating of the contaminant particles. The coating is generally a sticky organic material that, if allowed to build on the plates, can cause the charge on the plates to arc and short out.

To counteract the build-up of material on the electro-static precipitator 50, downstream of the secondary grease removal filter 46 and upstream of the electro-static precipitator is a first ultra-violet (“UV”) module 56 disposed in the hood plenum 26. The UV module 56 has at least one UV lamp 58, and extends generally perpendicularly to the flowpath “F” of the cooking exhaust and generates radiations that destroys and alters grease particulate of about 2 microns or smaller.

The UV module 56 emits radiation (light) having a wavelength of approximately 253.7 nm, which is a germicidal wavelength that breaks down the sticky organic build-up to base minerals. Specifically, the 235.7 nm radiation is directly exposed to the electro-static cell 52, which reduces the collected contaminates (such as grease and smoke) down to H₂O and CO₂. In other words, the radiation from the UV module 56 cleans the electro-static precipitator 50 from the upstream side of the precipitator to lessen the likelihood of it shorting out and failing. The UV module 56 changes the contaminate particles into a non-sticky, talc-like substance that does not stick to the electro-static precipitator 50. As a result, the plates of the electro-static precipitator 50 are actually cleaned during use, which reduces the likelihood of the plates shorting out, and reduces the amount of maintenance downtime in the ventilator assembly 10.

Downstream of the electro-static precipitator 50 at the upper portion 38 of the hood plenum 26 is optionally a second wash manifold 60 generally similar to the first wash manifold 42. The wash manifold 60 includes at least one spray nozzle 62 that provides water (shown schematically as broken lines), to remove the remaining accumulation of extracted grease and/or base minerals from the electro-static precipitator 50, as well as other portions of the hood plenum 26.

The exhaust portion 22 includes a duct 64 that is located downstream of the hood portion 12 and typically has a fan 66 for pulling gases through the ventilator assembly 10 and causing the flowpath F. Standard duct sizes include 12-inch by 24-inch, 10-inch by 10-inch, and 36-inch by 18-inch, although other duct sizes are contemplated. As is known in the art, the duct 64 may be in fluid communication with a pollution control unit (not shown). In the present embodiment, since the electro-static precipitator 50 is located in the hood plenum 26, the need for a pollution control unit (not shown) is obviated. Instead, the duct 64 extends to the exhaust fan 66 and to an outlet 74.

Incorporating both the UV module 56 and the electro-static precipitator 50 into the hood portion 12 allows for the removal of smoke from commercial cooking exhaust airflows without the need for costly and bulky pollution control units. The direct exposure of the electro-static cells 52 to the UV light prevents the cells from accumulating contaminants, which can cause their failure.

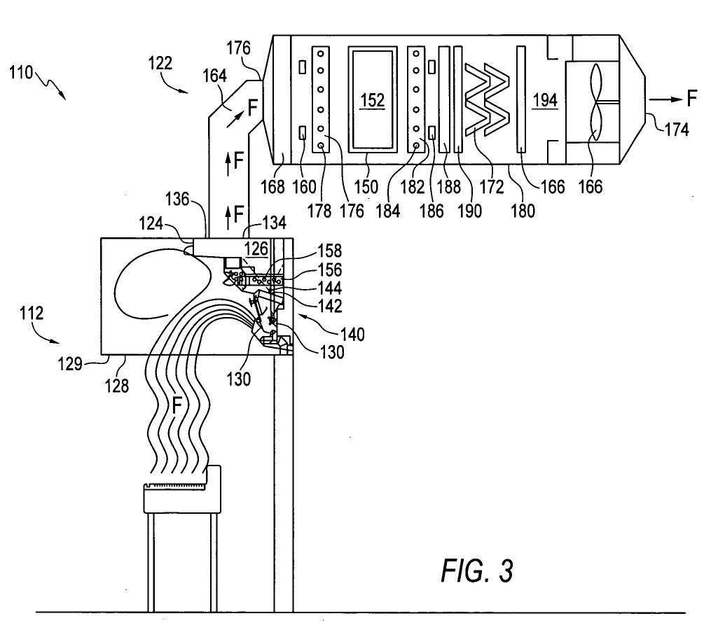

Referring now to FIG. 3, a second embodiment of ventilator assembly 110 has a pollution control unit 180 located in an exhaust portion 122 between a duct 164 and an outlet 174, where the pollution control unit includes an electro-static precipitator 150 with at least one electro-static cell 152. The exhaust portion 122 is located on the downstream side of the hood portion 112 and is in fluid communication with the hood portion. Similar to the first embodiment, the ventilator assembly 110 includes an outer housing 124 encompassing an interior hood plenum 126, and an air inlet aperture 128 is provided at a lower surface 129 of the hood portion 112.

In the hood plenum 126, multiple grease extraction baffles 130 alternate to create a winding flow path “F”, and a secondary grease removal filter 146 is located downstream of the baffles. An exhaust outlet 134 of the hood plenum 126 provides the fluid communication with the exhaust portion 122. The ventilator assembly 110 may be equipped with an optional water wash system 140 having a manifold 142 and a nozzle 144, and an optional UV module 156 with at least one UV lamp 158.

As is known in the art, the exhaust portion 122 includes a duct 164 and a fan 166 for pulling gases through the ventilator assembly 110. However, in the ventilator assembly 110, the exhaust portion 122 also includes the pollution control unit 180 having the electro-static precipitator 150, generally similar to the electro-static precipitator 50.

Following the direction of the flow path “F”, the cooking exhaust enters the pollution control unit 180 and flows through a pre-filter 168, which keeps the large grease particles from impinging on the ESP cells 152. Downstream of the pre-filer 168 is a wash manifold 160, and downstream of the wash manifold is a UV module 176 having at least one UV lamp 178. The UV module 176 is disposed upstream of the electro-static precipitator 150.

In contrast to the ventilator assembly 10, the ventilator assembly 110 has the electro-static precipitator 150 outside of the hood portion 112 and in the exhaust portion 122. Specifically, the electro-static precipitator 150 is disposed in a plenum 194 of the pollution control unit 180 downstream of the UV module 176. The electro-static precipitator 150 is configured for removing particulate that is about 0.3 microns or larger, which includes smoke, grease, odor and other contaminants. Since the contaminant particles are attracted to the charged plates of the electro-static precipitator 150, the plates become covered with a coating of the contaminant particles and require cleaning.

A UV module 182 having at least one UV lamp 184 is located downstream of the electro-static precipitator 150, and a wash manifold 186 is preferably located downstream of the UV module 182. Together, the UV module 176, the wash manifold 160, the UV module 182 and the wash manifold 186 keep the electro-static precipitator 150 clean.

Specifically, the upstream UV module 176 preferably emits radiation having a wavelength of approximately 253.7 nm that is directed downstream towards the electro-static precipitator 150 to clean the cells 52. The 253.7 nm radiation is directly exposed to the cells 52, which reduces the collected grease and smoke down to H₂O and CO₂.

The downstream UV module 182 preferably emits radiation having wavelengths of 253.7 nm and 185 nm. The 253.7 nm wavelength radiation is directed upstream towards the electro-static precipitator 150 to clean the cell 152 by direct exposure. The 253.7 nm wavelength radiation from both the UV module 176 and the UV module 182 breaks down the grease/exhaust contaminants of about 2 micron or smaller to base minerals.

The cooking exhaust that is not collected by the electro-static precipitator 150 reacts with the 185 nm wavelength radiation that is emitted from the downstream UV module 182. The 185 nm radiation reacts with the oxygen present in the cooking exhaust to produce ozone, which flows in the direction of the flow path “F” without reaching the electro-static precipitator 150. The ozone oxidizes the cooking exhaust downstream of the UV module 182.

In contrast, the UV module 176 preferably does not emit the 185 nm wavelength radiation because ozone would flow through the electro-static precipitator 150. Ozone in the electro-static precipitator 150 would oxidize the typically aluminum plates of the cell 152.

The exposure of the electro-static cells 152 to the UV module 176 upstream of the electro-static precipitator 150 and the UV module 182 downstream of the electro-static precipitator prevents the cells from accumulating contaminants, which can cause their failure. The wash manifolds 160, 186 wash away the base minerals from the electro-static precipitator 150.

A moisture separator 188 is located downstream of the wash manifold 182 to remove moisture introduced by the wash manifolds 160, 186 from the flow path “F”. In the preferred embodiment, a final filter 190 is disposed downstream of the moisture separator 188, and a carbon filter 172 is disposed downstream of the final filter. The carbon filter 172 uses activated carbon for odor removal. The ozone produced by the UV module 182 flows downstream with the flowpath “F” where it oxidizes organic contaminants deposited on the carbon filter 172, extending the life of the carbon filter.

In the preferred electro-static precipitator 150, an after filter 192 is disposed downstream of the carbon filter 172. The after filter 192 is configured to reduce and/or prevent the escaping carbon from flowing into the inlet of the fan 166.

It is contemplated that the pollution control device 180 can have different or additional components in the plenum 194. Further, the number of each component is not limited to one.

By placing the UV modules 176, 182 and the electro-static precipitator 150 in the pollution control unit 180, the hood portion 12 can be decreased in size, as compared to the first ventilator assembly 10. Further, placing the ozone-producing UV module 182 upstream of the carbon filter 172 in the pollution control unit 180, the life of the filter is prolonged.

While particular embodiments of the present ventilator assembly 10, 110 have been shown and described, it will be appreciated by those skilled in the art that changes and modifications may be made thereto without departing from the invention in its broader aspects and as set forth in the following claims.

1. A ventilator assembly for removing contaminants in cooking exhaust, comprising:
a hood portion having a hood plenum;
an exhaust portion downstream of and in fluid communication with said hood plenum;
an electro-static precipitator having an electro-static cell, wherein said electro-static precipitator is disposed in one of said hood plenum and said exhaust portion; and
at least one ultra-violet lamp for generating ultra-violet radiation disposed upstream of said electro-static precipitator, wherein said ultra-violet radiation reacts with the cooking exhaust and removes collected contaminants from said electro-static cell of said electro-static precipitator.

2. The ventilator assembly of claim 1 further comprising a wash manifold located upstream of said at least one ultra-violet lamp and configured for cleaning said at least one ultra-violet lamp.

3. The ventilator assembly of claim 1 further comprising a wash manifold located downstream of said electro-static precipitator for cleaning said electro-static precipitator.

4. The ventilator assembly of claim 1 further comprising a second ultra-violet lamp for generating ultra-violet radiation disposed downstream of said electro-static precipitator.

5. The ventilator assembly of claim 4 wherein said second ultra-violet lamp generates radiation having a wavelength of at least one of 185 nm and 253.7 nm.

6. The ventilator assembly of claim 5 wherein said 185 nm radiation from said second ultra-violet lamp oxidizes exhaust contaminants and cleans a carbon filter disposed downstream of said second ultra-violet lamp, and said 253.7 nm radiation reacts with the cooking exhaust and removes collected contaminants from said electro-static cell of said electro-static precipitator disposed upstream of said second ultra-violet lamp.

7. The ventilator assembly of claim 4 wherein said exhaust portion comprises a pollution control unit downstream of said hood plenum, and wherein said ultra-violet lamp and said second ultra-violet lamp are disposed in said pollution control unit.

8. The ventilator assembly of claim 1 wherein said ultra-violet lamp generates light having a wavelength of 253.7 nm to reduce the collected contaminants to H₂O and CO₂.

9. The ventilator assembly of claim 1 wherein said hood portion further comprises at least one secondary filter disposed downstream of a grease extraction baffle.

10. A ventilator assembly for removing contaminants in cooking exhaust, comprising:
a hood portion having a hood plenum;
an electro-static precipitator having an electro-static cell, wherein said electro-static precipitator is disposed in said hood plenum; and
at least one ultra-violet lamp for generating ultra-violet radiation disposed in said hood plenum upstream of said electro-static precipitator, wherein said ultra-violet radiation reacts with the cooking exhaust and removes collected contaminants from said electro-static cell of said electro-static precipitator.

11. The ventilator assembly of claim 10 further comprising a wash manifold located upstream of said at least one ultra-violet lamp for cleaning said at least one ultra-violet lamp.

12. The ventilator assembly of claim 10 further comprising a wash manifold located downstream of said electro-static precipitator for washing said electro-static precipitator.

13. The ventilator assembly of claim 10 wherein said at least one ultra-violet lamp emits radiation of about 253.7 nm.

14. The ventilator assembly of claim 10 wherein said electro-static precipitator is disposed in an upper portion of said hood portion.

15. A ventilator assembly for removing contaminants in cooking exhaust, comprising:
a hood portion having a hood plenum;
an exhaust portion downstream of and in fluid communication with said hood plenum;
an electro-static precipitator disposed said exhaust portion; and
at least one ultra-violet lamp for generating ultra-violet radiation disposed in said exhaust portion upstream of said electro-static precipitator, wherein said ultra-violet radiation reacts with the cooking exhaust and removes collected contaminants from said electro-static cell of said electro-static precipitator.

16. The ventilator assembly of claim 15 further comprising a pollution control unit disposed in the exhaust portion, wherein said electro-static precipitator is disposed in said pollution control unit.

17. The ventilator assembly of claim 16 wherein said at least one ultra-violet lamp is disposed in said pollution control unit upstream of said electro-static precipitator.

18. The ventilator assembly of claim 17 wherein a second ultra-violet lamp is disposed in said pollution control unit downstream of said electro-static precipitator.

19. The ventilator assembly of claim 18 wherein said ultra-violet lamp emits radiation of about 253.7 nm and said second ultra-violet lamp emits radiation of about 253.7 nm and 185 nm.

20. The ventilator assembly of claim 19 further comprising a first wash manifold disposed upstream of said electro-static precipitator and a second wash manifold disposed downstream of said electro-static precipitator.
